(19) United States
(12) Patent Application Publication
(10) Pub. No.: US 2015/0115700 A1
(43) Pub. Date: Apr. 30, 2015

(54) Brake System for a Motor Vehicle and Method for Controlling said Brake System

(71) Applicant: Robert Bosch GmbH, Stuttgart (DE)

(72) Inventors: Herbert Vollert, Vaihingen/Enz (DE); Reinhard Weiberle, Vaihingen/Enz (DE); Michael Kunz, Steinheim An Der Murr (DE); Jens Kolarsky, Bietigheim/Bissingen (DE)

(21) Appl. No.: 14/584,040

(22) Filed: Dec. 29, 2014

Related U.S. Application Data
(63) Continuation of application No. 13/140,573, filed on Jun. 17, 2011.

(30) Foreign Application Priority Data
Dec. 18, 2008 (DE) 10 2008 054 847.2

(51) Int. Cl. B60T 13/74; B60T 13/58; B60T 13/68

(52) U.S. Cl. CPC B60T 13/745; B60T 13/686; B60T 13/586
USPC 303/3

(57) ABSTRACT

A brake assembly includes a hydraulic auxiliary-power-operated first brake system including a master brake cylinder operably connected to an electromechanical brake booster and a hydraulic wheel brake for at least one wheel, the master brake cylinder configured to be activated by muscle force, and an externally powered second brake system including a hydraulic pressure source operated by external power and operably connected to a hydraulic wheel brake for at least one other wheel. The brake assembly further includes an electric drive motor configured for operation as a generator to brake the motor vehicle by acting on the at least one other wheel and a control unit configured to reduce a braking effect of the first brake system by reducing boosting of the electromechanical brake booster, if a braking effect of the electric drive motor in a generator mode is greater than the determined braking effect of the second brake system.

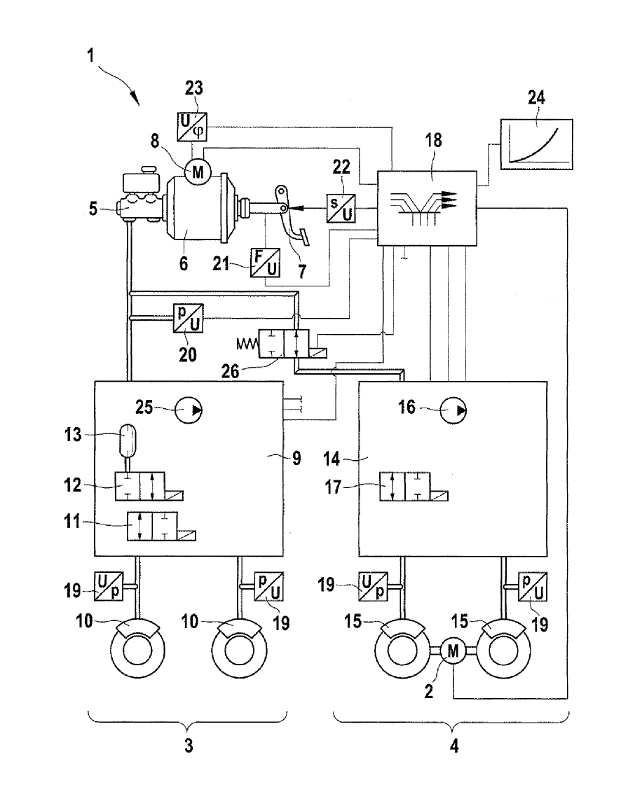

This application is a continuation application of co-pending application Ser. No. 13/140,573, filed on Jun. 17, 2011, which is a 35 U.S.C. §371 National Stage Application of PCT/EP2009/063910, filed Oct. 22, 2009, which in turn claims the benefit of priority to Application Serial No. DE 10 2008 054 847.2, filed on Dec. 18, 2008 in Germany, the disclosures of which are incorporated herein by reference in their entirety.

### FIELD

The disclosure relates to a brake system for a motor vehicle having a hydraulic muscle-power-operated or auxiliary-power-operated brake system having the features disclosed herein, and to a method for controlling the brake system. “Controlling” in the sense of the disclosure is understood to mean “open-loop controlling” as well as “closed-loop controlling.”

### BACKGROUND

Laid-open patent application DE 103 19 663 A1 discloses a brake system for a motor vehicle which has a hydraulic auxiliary-power-operated brake system and an electromechanical externally powered brake system. The auxiliary-power-operated brake system acts, for example, on wheels of a front axle, and the externally powered brake system acts, for example, on wheels of a rear axle of the motor vehicle. The auxiliary-power-operated brake system is of a design known per se and has a master brake cylinder which can be activated by muscle force, for example by a (foot-operated) brake pedal or by a (manually operated) brake lever, to which master brake cylinder hydraulic wheel brakes are connected. The master brake cylinder has an underpressure brake booster, the boosting of which can be controlled independently of the muscle-powered activation.

The externally powered brake system has electromechanical wheel brakes which can, for example, be applied by an electric motor via a transmission. Electromechanical wheel brakes of a self-energizing and non-self-energizing design are known, and reference is made with respect to an electromechanical wheel brake to the laid-open patent application DE 100 56 451 A1.

Irrespective of the type of brake system, what are referred to as hybrid vehicles with an internal combustion engine and an electric drive motor (or else a plurality of electric drive motors) are known which, depending on the driving situation, are driven by the internal combustion engine, the electric drive motor or else by both. For the purpose of braking, the electric drive motor can be operated as a generator. The braking power of the electric drive motor in the generator mode is dependent, inter alia, on the velocity of the vehicle, and braking to a stationary state is not possible with the electric drive motor. The braking effect of the electric drive motor in the generator mode is also dependent on the charge state of a vehicle battery (actually an accumulator), and when the vehicle battery is fully charged braking with the electric drive motor in the generator mode is not possible. Even if a clutch pedal is depressed when shifting gear with a non-automatic transmission, the electric drive motor is mechanically separated from the vehicle wheels if the electric drive motor is not assigned to the vehicle wheels, with the result that the braking effect is interrupted. The compensation of the braking effect of the electric drive motor in the generator mode with respect to the overall braking effect of the vehicle can be left to a vehicle driver. It is also possible to carry out, for example, electronic control of the braking effect of the brake system, which compensates to a more or less satisfactory degree the portion of the braking effect which is provided by the electric drive motor. The control of the braking effect of the brake system as a function of the braking effect of the electric drive motor in the generator mode can be referred to as “blending.”

### SUMMARY

According to an exemplary embodiment of the disclosure, a brake assembly for a motor vehicle includes a hydraulic auxiliary-power-operated first brake system, an externally powered second brake system, an electric drive motor, and a control unit. The hydraulic auxiliary-power-operated first brake system includes a master brake cylinder operably connected to an electromechanical brake booster and a hydraulic wheel brake for at least one wheel. The master brake cylinder is configured to be activated by muscle force. The externally powered second brake system includes a hydraulic pressure source operated by external power and is operably connected to a hydraulic wheel brake for at least one other wheel. The electric drive motor is configured for operation as a generator to brake the motor vehicle by acting on the at least one other wheel. The control unit is configured (i) to determine a braking effect of the second brake system for a current position of a brake pedal, and (ii) to reduce a braking effect of the first brake system by reducing boosting of the electromechanical brake booster, if a braking effect of the electric drive motor in a generator mode is greater than the determined braking effect of the second brake system.

According to another exemplary embodiment of the disclosure, a method is provided for controlling an activation of a brake assembly for a motor vehicle, having a hydraulic auxiliary-power-operated first brake system operated by muscle force and including a master brake cylinder operably connected to an electromechanical brake booster and a hydraulic wheel brake for at least one wheel, an externally powered second brake system including a hydraulic pressure source operated by external power and operably connected to a hydraulic wheel brake for at least one other wheel, and an electric drive motor configured for operation as a generator to brake the motor vehicle by acting on the at least one other wheel. The method includes determining a braking effect of the second brake system for a current position of a brake pedal of the brake assembly with a control unit of the brake assembly, and reducing a braking effect of the first brake system by reducing boosting of the electromechanical brake booster, if a braking effect of the electric drive motor in a generator mode is greater than the determined braking effect of the second brake system.

According to yet another exemplary embodiment of the disclosure, a method is provided for controlling an activation of a brake assembly for a motor vehicle, having a hydraulic auxiliary-power-operated first brake system operated by muscle force and including a master brake cylinder operably connected to an electromechanical brake booster and a hydraulic wheel brake for at least one wheel, an externally powered second brake system including a hydraulic pressure source operated by external power and operably connected to a hydraulic wheel brake for at least one other wheel, and an electric drive motor configured for operation as a generator to brake the motor vehicle by acting on the at least one other wheel. The method includes determining a braking effect of the first brake system for a current position of a brake pedal of the brake assembly with a control unit of the brake assembly, determining a braking effect of the second brake system for the current position of the brake pedal with the control unit, and determining a braking effect of the electric drive motor in a generator mode with the control unit. The method further includes reducing the determined braking effect of the first brake system if the determined braking effect of the electric drive motor is greater than the determined braking effect of the second brake system, and applying the reduced determined braking effect of the first brake system to the at least one wheel and the determined braking effect of the electric drive motor to the at least one other wheel without applying the determined braking effect of the second brake system to the at least one other wheel.

The brake system according to the disclosure has a hydraulic muscle-power-operated or auxiliary-power-operated brake system and a hydraulic externally powered brake system. An auxiliary-power-operated brake system means that the master brake cylinder has a brake booster. A brake booster is, at any rate for simple embodiments of the disclosure, not absolutely necessary, for which reason a muscle-power-operated brake system is also possible. The externally powered brake system has a hydraulic pressure source which is operated by external power, for example a hydraulic pump, which is driven by an electric motor. The brake system according to the disclosure is suitable for “blending”, that is to say for compensating the braking effect of an electric drive motor, which is operated as a generator, in a motor vehicle. In particular, the braking effect of the brake system is reduced, and this brakes the vehicle wheels which are driven with the electric drive motor. In this way, the distribution of the braking force between the front axle and the rear axle is not changed by the braking effect of the electric drive motor in the generator mode. A controllable brake booster permits the muscle power which is necessary to activate the brakes to be increased by reducing the boosting by the brake booster. As a result, the customary muscle power for activating the brakes is possible if the braking effect of the brake system is reduced in order to compensate the braking effect of the electric drive motor in the generator mode.

Advantageous refinements and developments of the disclosure are also set forth.

By means of a valve which is referred to as a back-up valve it is possible to connect the externally powered brake system hydraulically to the master brake cylinder of the muscle-power-operated or auxiliary-power-operated brake system. The externally powered brake system can therefore be used as a muscle-power-operated or auxiliary-power-operated brake system if its external power source fails.

The method described herein discloses a means of controlling the brake system and they are directed, in particular, at achieving a constant pedal characteristic curve. The pedal characteristic curve represents the dependence of the muscle power necessary to activate the master brake cylinder on the pedal travel. When satisfactory control takes place, a vehicle driver does not notice that the braking effect of the brake system is reduced in order to compensate the braking effect of the electric drive motor in the generator mode, to be precise the driver does not notice this even if the braking effect of the electric drive motor changes in the generator mode.

### BRIEF DESCRIPTION OF THE DRAWING

The features of the disclosure will be described below in more detail with reference to an embodiment which is illustrated in the drawing. The single FIGURE shows a schematic illustration of a brake system according to the disclosure. The illustration is partially simplified and serves to explain and promote understanding of the disclosure.

### DETAILED DESCRIPTION

The brake system 1 as disclosed herein, which is illustrated in the FIGURE, is provided for a motor vehicle (not illustrated) with drive by means of an electric drive motor 2. In the exemplary embodiment, the electric drive motor 2 acts on the two wheels of a vehicle axle, for example the rear axle. The electric drive motor 2 can also act on all the vehicle wheels, and a separate electric drive motor is also possible for each driven vehicle wheel. For the purpose of braking, the electric drive motor 2 can be operated as a generator. The motor vehicle can have an exclusively electro-motive drive; and it can also be what is referred to as a hybrid vehicle with a drive by means of an internal combustion engine (not illustrated) and the electric drive motor 2, wherein the drive can be provided by the internal combustion engine, the electric drive motor 2, or for example by means of both in order to provide strong acceleration, depending on the driving state and the driver's wishes. Although the features of the disclosure are provided for the electric drive motor 2 which can be operated for the purpose of braking as a generator, irrespective of whether or not an internal combustion engine is also present, the features of the disclosure are basically possible even without an electric drive motor 2.

The brake system 1 has a hydraulic auxiliary-power-operated brake system 3 and a hydraulic externally powered brake system 4, wherein the auxiliary-power-operated brake system 3 acts on the vehicle wheels of one axle, and the externally powered brake system 4 acts on the vehicle wheels of another axle. Both brake systems 3, 4 are service brake systems.

The auxiliary-power-operated brake system 3 has a master brake cylinder 5 with an electromechanical brake booster 6. The master brake cylinder 5 is activated by muscle force with a (foot-operated) brake pedal 7. The brake booster 6 can be controlled, i.e. its power or boosting can be controlled, in which case “control” is to be understood as meaning “open-loop control” as well as “closed-loop control.” The brake booster 6 has an electric motor 8 with which a force can be applied to the master brake cylinder 5 via a transmission (not illustrated individually), to be more precise the force can be applied to a piston of the master brake cylinder 5. The brake booster 6 can also have a linear motor or an electromagnet for generating the boosting power. An electromechanical brake booster with an electromagnet or optionally a linear motor is disclosed by laid-open patent application DE 100 57 557 A1.

Hydraulic wheel brakes 10, which, as already stated, are assigned to the vehicle wheels of a vehicle axle, for example the front axle, are connected to the master brake cylinder 5 via a hydraulic unit 9. The hydraulic unit 9 contains hydraulic components of a slip controller such as, for example, a hydraulic pump 25, brake-pressure-increasing valves 11, brake-pressure-decreasing valves 12 and a hydraulic accumulator 13, which are illustrated only in exemplary form in the drawing. Such hydraulic units 9 are known per se and will therefore not be explained at this point. The hydraulic unit 9 permits, as stated, slip control, for example anti-lock brake control, traction control and/or vehicle movement dynamics control for which abbreviations such as ABS, TCS, ESP and VMDC are customary. The hydraulic pump 25 of such slip controllers is also referred to as a feedback pump.

The externally powered brake system 4 also has a hydraulic unit 14 to which hydraulic wheel brakes 15 are connected, the wheel brakes 15 also being assigned to a vehicle axle, in particular the rear axle. The externally powered brake system 4 preferably acts on the vehicle axle whose vehicle wheels can be driven with the electric drive motor 2 and which can be braked in the generator mode of the electric drive motor 2. The hydraulic unit 14 of the externally powered brake system 4 has a hydraulic pump 16 which can be driven with an electric motor (not illustrated) and which forms a hydraulic pressure source which is operated by external power. For the purpose of slip control, brake pressure-increasing and brake-pressure decreasing valves are present, one valve 17 of which is illustrated symbolically.

The externally powered brake system 4 is connected hydraulically to the master brake cylinder 5 of the auxiliary-power-operated brake system 3 via a valve, which is referred to here as a back-up valve 26. As a result, the externally powered brake system 4 can be activated together with the auxiliary-power-operated brake system 3, with the master brake cylinder 5 thereof, if a hydraulic pump 16 or its electric motor fails. The externally powered brake system 4 functions here as an auxiliary-power-operated brake system. In the illustration, the back-up valve 26 is a 2/2 way solenoid valve which is open in its non-energized basic position and which is normally energized (for example when an ignition of a motor vehicle is switched on) and as a result is closed, and which is opened when the hydraulic pump 16 or its electric motor fails. It is also possible to use as a back-up valve 26 a valve which is closed in the non-energized state.

For performing open-loop or closed-loop control of both brake systems 3, 4, an electronic control unit 18 is present with which wheel-specific open-loop or closed-loop control of the braking force is possible. The control unit 18 also controls the electric drive motor 2 including the generator mode thereof, and the brake booster 6. The control unit 18 receives signals from various sensors, for example from wheel brake pressure sensors 19 which are assigned to each wheel brake 10, 15, from a pressure sensor 20 for the master brake cylinder 5, from a pedal force sensor 21, a pedal travel sensor 22 and a position sensor 23 of the brake booster.

The auxiliary-power-operated brake system 3 is, like the externally powered brake system 4, embodied as a single-circuit brake system because in the event of a failure of one of the two brake systems 3, 4 braking is possible with the respective other brake system 4, 3.

If the brake pedal 7 is activated in order to activate the brakes, the electric drive motor 2 is operated as a generator, insofar as this is permitted by the operating state, and the braking effect of the brake system 1 is reduced in accordance with the braking effect of the electric drive motor 2 in the generator mode. In other words, if possible the braking effect generated by the brake system 1 and the electric drive motor 2 in the generator mode is that which would be achieved for the given position of the brake pedal 7 with the brake system 1 without the electric drive motor 2. The braking effect of the externally powered brake system 4 is preferably reduced by an amount equal to the braking effect of the electric drive motor 2 in the generator mode, or in other words the braking effect of the brake system 4 which acts on the vehicle wheels on which the electric drive motor 2 also acts is reduced. As a result, the braking force distribution between the vehicle axles is not changed by the braking effect of the electric drive motor 2 in the generator mode.

If the braking effect of the electric drive motor 2 in the generator mode is greater than the braking effect of the externally powered brake system 4 should be for a given position of the brake pedal 7 without the braking effect of the electric drive motor 2, the braking effect of the auxiliary-power-operated brake system 3 is also reduced, with the result that an overall braking effect of the electric drive motor 2 in the generator mode and of the brake system 1 corresponds to that which the brake systems 1 should have without the braking effect of the electric drive motor 2 for the given position of the brake pedal 7. In the case described, the braking effect of the externally powered brake system 4 is zero, and the braking effect of the brake system 1 is the braking effect of the auxiliary-power-operated brake system 3. The distribution of the braking force between the vehicle axles changes in the described case compared to the braking force distribution which the brake system 1 would have without the braking effect of the electric drive motor 2.

The boosting by the brake booster 6 is reduced if the braking effect of the electric drive motor 2 in the generator mode is greater than the braking effect of the externally powered brake system 4 should be for a given position of the brake pedal 7 without the braking effect of the electric drive motor 2, and as a result of this the braking effect of the auxiliary-power-operated brake system 3 is also correspondingly reduced, with the result that an activation force at the brake pedal 7 does not change as a result of the braking effect of the electric drive motor 2 in the generator mode, and the associated reduction in the braking effect of the brake system 1. A pedal characteristic curve remains, as much as possible, unchanged by the braking effect of the electric drive motor 2 in the generator mode. The pedal characteristic curve is the dependence of the pedal force on the pedal position, and in the exemplary embodiment it is represented symbolically by the reference number 24. Control of the pedal characteristic curve is also possible by controlling a Springer function of the brake booster 6, which is also referred to as a “jump in.” In the Springer function, when the braking force of the brake system 1 is low the activation force applied to the master brake cylinder 5 is generated completely by the brake booster 6 as a function of the position of the brake pedal 7, and the pedal force is constant and low. The Springer function relates to a first part of the pedal travel. To be more precise, it comprises externally powered braking with the force of the brake booster 6.

If the braking effect of the auxiliary-power-operated brake system 3 itself is too high without the effect of the brake booster 6, brake fluid is let out from the wheel brakes 10 into the hydraulic accumulator 13 through the associated brake-pressure-decreasing valves 12, and as a result the braking force is reduced. By means of the brake-pressure-increasing valves 11 and the brake-pressure-decreasing valves 12, the hydraulic accumulator 13 and the hydraulic pump 25, it is possible to modulate the brake pressure in the wheel brakes 10 and therefore to carry out the desired reduction of the braking force of the auxiliary-power-operated brake system 3, to zero if necessary. The pedal force which is customary for a given position of the brake pedal 7 can be generated with the brake booster 6 insofar as a force which is opposed to the activation direction of the master brake cylinder 5, that is to say an opposing force to a muscle force applied to the brake pedal 7, can be generated by the brake booster 6. The brake booster 6 acts in this case as a pedal simulator with which a customary pedal force which is dependent on the position of the brake pedal 7 can be generated, even if a hydraulic pressure in the master brake cylinder 5 drops, and under certain circumstances even drops as far as zero. Customary pedal force is to be understood here as the muscle force which is applied to the brake pedal 7 when the brake is activated without the braking effect of the electric drive motor 2. The muscle force is dependent on the position of the brake pedal 7 and on the travel caused by the depression of the brake pedal 7, and the position and the travel are measured with the pedal travel sensor 22.

What is claimed is:

1. A brake assembly for a motor vehicle, comprising:
a hydraulic auxiliary-power-operated first brake system including a master brake cylinder operably connected to an electromechanical brake booster and a hydraulic wheel brake for at least one wheel, the master brake cylinder configured to be activated by muscle force;
an externally powered second brake system including a hydraulic pressure source operated by external power and operably connected to a hydraulic wheel brake for at least one other wheel;
an electric drive motor configured for operation as a generator to brake the motor vehicle by acting on the at least one other wheel; and
a control unit configured (i) to determine a braking effect of the second brake system for a current position of a brake pedal, and (ii) to reduce a braking effect of the first brake system by reducing boosting of the electromechanical brake booster, if a braking effect of the electric drive motor in a generator mode is greater than the determined braking effect of the second brake system.

2. The brake assembly as claimed in claim 1, further comprising:
a back-up valve configured to connect the second brake system to the master brake cylinder in response to failure of a portion of the second brake system.

3. The brake assembly as claimed in claim 1, further comprising:
a hydraulic accumulator connected to the first brake system via a valve,
wherein the braking effect of the first brake system is further reduced by transferring brake fluid from the first brake system into the hydraulic accumulator through the valve.

4. The brake assembly as claimed in claim 1, wherein the braking effect of the first brake system is reduced in such a way that a regenerative and friction braking effect including the braking effect of the electric drive motor in the generator mode, the braking effect of the first brake system, and the braking effect of the second brake system corresponds to a friction braking effect including the braking effect of the first brake system and the braking effect of the second brake system for the current position of the brake pedal.

5. The brake assembly as claimed in claim 1, wherein the boosting of the electromechanical brake booster is reduced in such a way that an activation force at the brake pedal does not change as a result of the braking effect of the electric drive motor in the generator mode and the reduction in the braking effect of the first brake system.

6. The brake assembly as claimed in claim 1, wherein the first brake system is separate from and independent of the second brake system.

7. A method for controlling an activation of a brake assembly for a motor vehicle, having a hydraulic auxiliary-power-operated first brake system operated by muscle force and including a master brake cylinder operably connected to an electromechanical brake booster and a hydraulic wheel brake for at least one wheel, an externally powered second brake system including a hydraulic pressure source operated by external power and operably connected to a hydraulic wheel brake for at least one other wheel, and an electric drive motor configured for operation as a generator to brake the motor vehicle by acting on the at least one other wheel, the method comprising:
determining a braking effect of the second brake system for a current position of a brake pedal of the brake assembly with a control unit of the brake assembly; and
reducing a braking effect of the first brake system by reducing boosting of the electromechanical brake booster, if a braking effect of the electric drive motor in a generator mode is greater than the determined braking effect of the second brake system.

8. The method as claimed in claim 7, wherein a hydraulic accumulator is connected to the first brake system via a valve, and the method further comprises:
further reducing the braking effect of the first brake system by transferring brake fluid from the first brake system into the hydraulic accumulator through the valve.

9. The method as claimed in claim 7, further comprising:
reducing the braking effect of the first brake system in such a way that a regenerative and friction braking effect including the braking effect of the electric drive motor in the generator mode, the braking effect of the first brake system, and the braking effect of the second brake system corresponds to a friction braking effect including the braking effect of the first brake system and the braking effect of the second brake system for the current position of the brake pedal.

10. The method as claimed in claim 7, further comprising:
reducing the boosting by the electromechanical brake booster in such a way that an activation force at the brake pedal does not change as a result of the braking effect of the electric drive motor in the generator mode and the associated reduction in the braking effect of the first brake system.

11. The method as claimed in claim 7, further comprising:
controlling the first brake system in accordance with a constant pedal characteristic curve.

12. The method as claimed in claim 7, further comprising:
controlling the first brake system in accordance with a pedal characteristic curve which is unchanged in the generator mode of the electric drive motor compared to a non-generator mode.

13. A method for controlling an activation of a brake assembly for a motor vehicle, having a hydraulic auxiliary-power-operated first brake system operated by muscle force and including a master brake cylinder operably connected to an electromechanical brake booster and a hydraulic wheel brake for at least one wheel, an externally powered second brake system including a hydraulic pressure source operated by external power and operably connected to a hydraulic wheel brake for at least one other wheel, and an electric drive motor configured for operation as a generator to brake the motor vehicle by acting on the at least one other wheel, the method comprising:
determining a braking effect of the first brake system for a current position of a brake pedal of the brake assembly with a control unit of the brake assembly;
determining a braking effect of the second brake system for the current position of the brake pedal with the control unit;
determining a braking effect of the electric drive motor in a generator mode with the control unit;
reducing the determined braking effect of the first brake system if the determined braking effect of the electric drive motor is greater than the determined braking effect of the second brake system; and
applying the reduced determined braking effect of the first brake system to the at least one wheel and the determined braking effect of the electric drive motor to the at least one other wheel without applying the determined braking effect of the second brake system to the at least one other wheel.

14. The method of claim 13, further comprising:
determining a regenerative braking excess with the control unit as a difference between the determined braking effect of the electric drive motor and the determined braking effect second brake system,
wherein the determined braking effect of the first brake system is reduced by the regenerative braking excess.

15. The method of claim 14, further comprising:
reducing the determined braking effect of the first brake system by reducing boosting of the electromechanical brake booster.

16. The method as claimed in claim 15, further comprising:
reducing the boosting by the electromechanical brake booster in such a way that an activation force at the brake pedal does not change as a result of the braking effect of the electric drive motor in the generator mode and the associated reduction in the determined braking effect of the first brake system.

17. The method as claimed in claim 13, further comprising:
controlling the first brake system in accordance with a constant pedal characteristic curve.

18. The method as claimed in claim 13, further comprising:
controlling the first brake system in accordance with a pedal characteristic curve which is unchanged in the generator mode of the electric drive motor compared to a non-generator mode.
